(19) United States
(12) Patent Application Publication
(10) Pub. No.: US 2025/0060741 A1
(43) Pub. Date: Feb. 20, 2025

(54) PREDICTIVE DETECTION APPARATUS, PREDICTIVE DETECTION SYSTEM, AND PREDICTIVE DETECTION METHOD

(71) Applicant: Hitachi, Ltd., Chiyoda-ku, Tokyo (JP)

(72) Inventor: Tohru NOJIRI, Tokyo (JP)

(21) Appl. No.: 18/696,932

(22) PCT Filed: Oct. 21, 2022
(86) PCT No.: PCT/JP2022/039330

§ 371 Date: Oct. 29, 2024

(30) Foreign Application Priority Data
Nov. 2, 2021 (JP) 2021-179176

(51) Int. Cl. G05B 23/02; G05D 23/19

(52) U.S. Cl. CPC G05B 23/0283; G05D 23/1927

(57) ABSTRACT

A predictive detection apparatus includes a preprocessing section that acquires a chronological feature amount indicating an operational status of an apparatus to be cooled which includes a heat source and a cooling section that cools the heat source with a cooling medium, and a model creation section that generates a training data set in reference to the chronological feature amount acquired by the preprocessing section and a label indicating whether a cooling capability provided by the cooling section is normal or abnormal, and that uses the training data set to create a predictive detection model.

### INCORPORATION BY REFERENCE

The present application claims the priority to Japanese Patent Application No. 2021-179176 filed on Nov. 2, 2021, the contents of which are incorporated herein by reference.

### TECHNICAL FIELD

The present invention relates to a predictive detection apparatus, a predictive detection system, and a predictive detection method for detecting a predictive sign.

### BACKGROUND ART

An oil cooling apparatus is provided in an apparatus to be cooled, and cools, to an appropriate range, oil in the apparatus to be cooled, when an operational status of the apparatus to be cooled is within a rated range of the apparatus to be cooled. Accordingly, the apparatus to be cooled is prevented from being brought into an abnormal state. However, when the cooling capability of the oil cooling apparatus is degraded, oil temperature in the apparatus to be cooled increases and brings the apparatus to be cooled into the abnormal state, making it difficult for the apparatus to be cooled to perform safe and stable operations. Typically, when the oil temperature increases and brings the apparatus to be cooled into the abnormal state, a check mechanism of the oil cooling apparatus is activated to stop the operation of the apparatus to be cooled.

Further, Patent Document 1 listed below discloses a failure predictive diagnosis system including a diagnosis execution section, a placement section, equipment to be diagnosed, a diagnosis server, and a network. In the failure predictive diagnosis system, the diagnosis execution section includes processing modules for sensor input processing, preprocessing, diagnosis processing, and postprocessing, and a common interface to which the processing modules are connected, and the placement section places the processing modules on the equipment to be diagnosed or the diagnosis server, and executes the processing modules.

### PRIOR ART DOCUMENT

### Patent Document

Patent Document 1: JP-2016-12157-A

### SUMMARY OF THE INVENTION

### Problems to be Solved by the Invention

Factors for a degraded cooling capability of the oil cooling apparatus include a clogged oil cooler, a clogged oil filter, degraded oil quality, degraded oil piping, and the like. The degraded cooling capability of the oil cooling apparatus emerges as a difference in oil temperature with respect to the same load on the apparatus to be cooled. However, the degraded cooling capability of the oil cooling apparatus emerges as a significant difference in oil temperature at a high load, but not at a low load. Accordingly, the predictive detection of the degraded cooling capability based on the difference in oil temperature is difficult.

An object of the present invention is to increase the accuracy of predictive detection of the degraded cooling capability.

### Means for Solving the Problems

According to an aspect of the present invention disclosed herein, a predictive detection apparatus includes a preprocessing section that acquires a chronological feature amount indicating an operational status of an apparatus to be cooled which includes a heat source and a cooling section that cools the heat source with a cooling medium, and a model creation section that generates a training data set in reference to the chronological feature amount acquired by the preprocessing section and a label indicating whether a cooling capability provided by the cooling section is normal or abnormal, and that uses the training data set to create a predictive detection model.

### Advantages of the Invention

According to a typical embodiment of the present invention, the accuracy of predictive detection of a degraded cooling capability can be increased. Problems, configurations, and effects other than those described above will be clarified from description of examples below.

### BRIEF DESCRIPTION OF THE DRAWINGS

FIG. 1 is a block diagram illustrating a system configuration example of a predictive detection system.

FIG. 2 is a block diagram illustrating detailed System Configuration Example 1 of the predictive detection system.

FIG. 3 is a block diagram illustrating detailed System Configuration Example 2 of the predictive detection system.

FIG. 4 is a block diagram illustrating a configuration example of an apparatus to be cooled.

FIG. 5 is a block diagram illustrating a hardware configuration example of a computer.

FIG. 6 is an explanatory diagram illustrating an example of a sensor data table.

FIG. 7 is an explanatory diagram illustrating an example of a training data set table.

FIG. 8 is a graph illustrating chronological data regarding a discharge temperature and an ambient temperature.

FIG. 9 is an explanatory diagram illustrating a Generation Example 1 of a predictive detection model.

FIG. 10 is an explanatory diagram illustrating a Generation Example 2 of the predictive detection model.

### MODES FOR CARRYING OUT THE INVENTION

### <System Configuration Example of Predictive Detection System>

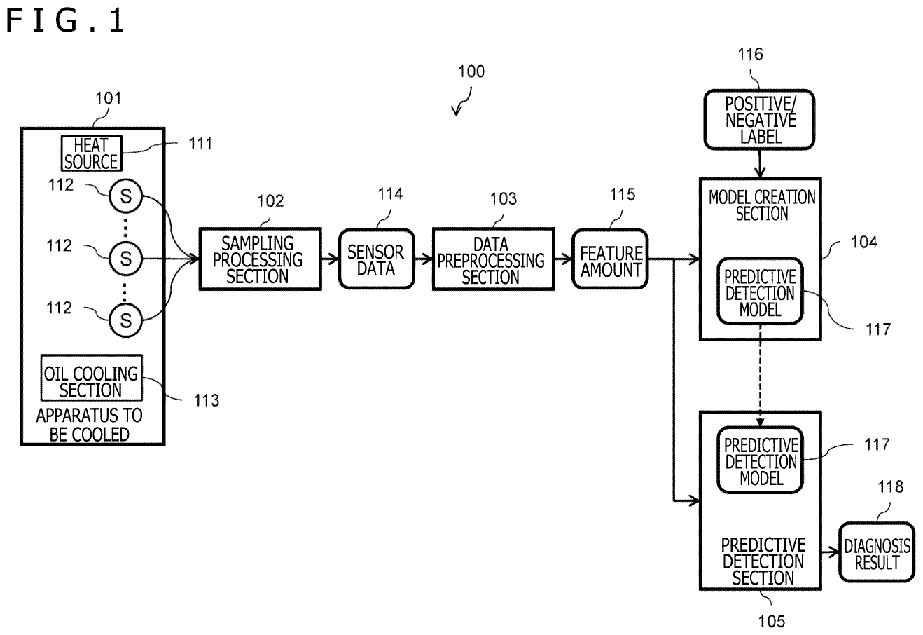

FIG. 1 is a block diagram illustrating a system configuration example of a predictive detection system. A predictive detection system 100 includes an apparatus to be cooled 101, a sampling processing section 102, a data preprocessing section 103, a model creation section 104, and a predictive detection section 105.

The apparatus to be cooled 101 includes a heat source 111, sensors 112, and an oil cooling section 113. The heat source 111 is a source of heat in the apparatus to be cooled 101, and is a motor in a case where the apparatus to be cooled 101 is, for example, an air compressor. The sensors 112 detect various operational statuses in the apparatus to be cooled 101. The sensors 112 are, for example, a temperature sensor, an ammeter, and a pressure sensor. The oil cooling section 113 is a mechanism that cools oil circulating in the apparatus to be cooled 101. The present example will be described taking oil as an example of a cooling medium. However, the kind of cooling medium to be used depends on the type of the apparatus to be cooled 101, and thus a cooling medium other than oil may be used, such as water or chlorofluorocarbon.

The sampling processing section 102 converts analog data from the sensors 112 into digital data, and outputs the digital data as sensor data 114.

By excluding outliers from the sensor data 114 or interpolating the sensor data 114 at missing points of time, the data preprocessing section 103 outputs the resultant sensor data 114 as feature amounts 115.

The model creation section 104 uses the feature amount 115 and a positive/negative label 116 as a training data set to create a predictive detection model 117. Specifically, for example, the model creation section 104 uses the training data set to generate the predictive detection model 117 by, for example, decision trees, random forests, or deep learning.

The predictive detection section inputs the feature amount 115 to the predictive detection model 117, to output a diagnosis result 118 indicating a predictive sign of a degraded cooling capability of the oil cooling section 113.

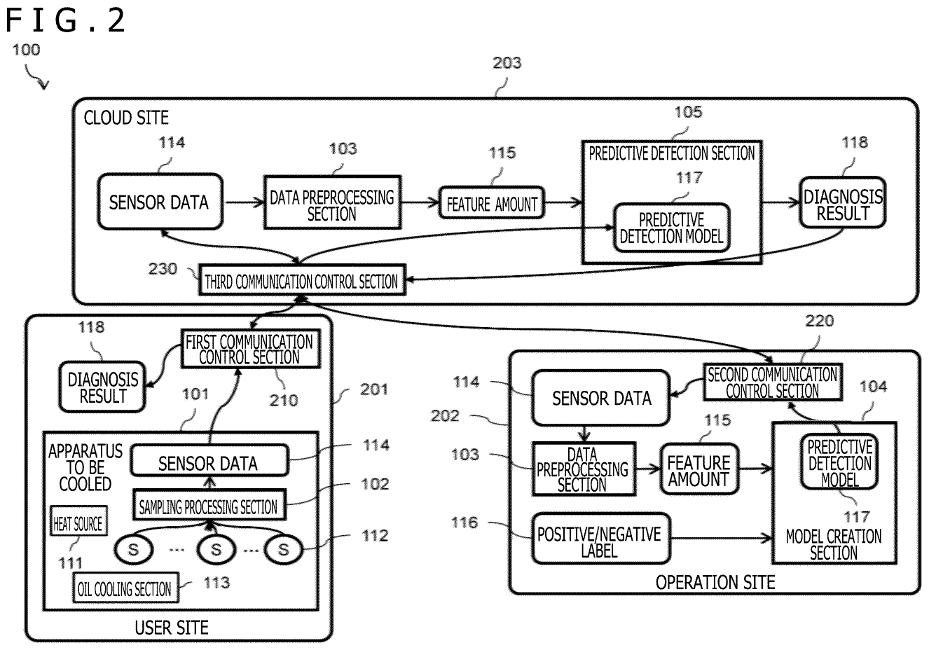

FIG. 2 is a block diagram illustrating detailed System Configuration Example 1 of the predictive detection system 100. The predictive detection system 100 includes a user site 201, an operation site 202, and a cloud site 203. The user site 201 and the cloud site 203 are connected in a manner allowing communication therebetween and the operation site 202 and the cloud site 203 are connected in a manner allowing communication therebetween, via a network such as the Internet, a LAN (Local Area Network), or a WAN (Wide Area Network).

The user site 201 includes the apparatus to be cooled 101 and a first communication control section 210. In FIG. 2, the sampling processing section 102 is included in the apparatus to be cooled 101 but may instead be provided outside the apparatus to be cooled 101 as long as the sampling processing section 102 is included within the user site 201.

The operation site 202 includes the data preprocessing section 103, the model creation section 104, and a second communication control section 220.

The cloud site 203 includes the data preprocessing section 103, the predictive detection section 105, and a third communication control section 230.

First, creation processing for the predictive detection model 117 in System Configuration Example 1 will be described. In the user site 201, the apparatus to be cooled 101 outputs, to the sampling processing section 102, analog data detected by the sensors 112, and the sampling processing section 102 outputs the sensor data 114 to the first communication control section 210. The user site 201 causes the first communication control section 210 to transmit the sensor data 114 to the third communication control section 230 of the cloud site 203.

The cloud site 203 causes the third communication control section 230 to transfer the sensor data 114 from the user site, to the second communication control section 2 of the operation site 202.

In the operation site 202, the data preprocessing section 103 acquires the sensor data 114 received by the second communication control section 220, and outputs the feature amount 115 to the model creation section 104. The model creation section 104 uses the training data set (the feature amount 115 and the positive/negative label 116) to create the predictive detection model 117, and outputs the predictive detection model 117 to the second communication control section 220. The second communication control section 220 transmits the predictive detection model 117 to the third communication control section 230 of the cloud site 203.

In the cloud site 203, the third communication control section 230 outputs the predictive detection model 117 from the operation site 202, to the predictive detection section 105.

Now, predictive detection processing by the predictive detection model 117 in System Configuration Example 1 will be described. In the user site 201, the apparatus to be cooled 101 outputs, to the sampling processing section 102, analog data detected by the sensors 112, and the sampling processing section 102 outputs the sensor data 114 to the first communication control section 210. The user site 201 causes the first communication control section 210 to transmit the sensor data 114 to the third communication control section 230 of the cloud site 203.

In the cloud site 203, the third communication control section 230 outputs the sensor data 114 from the user site 201, to the data preprocessing section 103. By excluding outliers from the sensor data 114 or interpolating the sensor data 114 at missing points of time, the data preprocessing section 103 outputs the feature amount 115 to the predictive detection section 105. The predictive detection section 105 inputs the feature amount 115 to the predictive detection model 117, and outputs the diagnosis result 118 indicating a predictive sign of a degraded cooling capability of the oil cooling section 113.

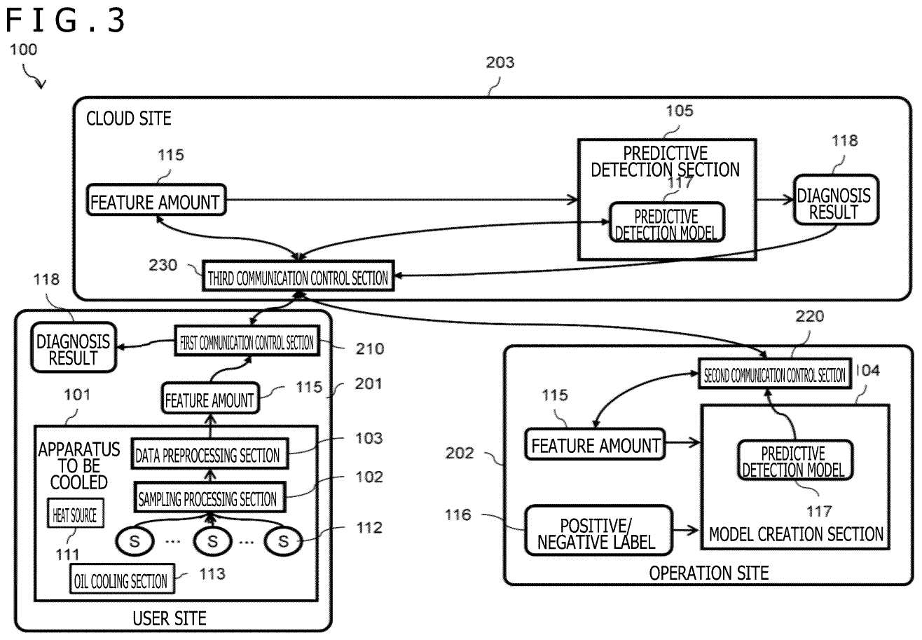

FIG. 3 is a block diagram illustrating detailed System Configuration Example 2 of the predictive detection system 100. The following description focuses on differences from System Configuration Example 1.

The user site 201 includes the apparatus to be cooled 101 and the first communication control section 210. In FIG. 3, the sampling processing section 102 and the data preprocessing section 103 are included in the apparatus to be cooled 101 but may instead be provided outside the apparatus to be cooled 101 as long as the sampling processing section 102 and the data preprocessing section 103 are included within the user site 201.

The operation site 202 includes the model creation section 104 and the second communication control section 220.

The cloud site 203 includes the predictive detection section 105 and the third communication control section 230.

In System Configuration Example 2, the data preprocessing section 103 is present only in the user site 201. That is, when the user site 201 generates the feature amount 115, creation of the predictive detection model 117 and predictive detection are enabled using the sensor data 114 having a shorter sampling period than the sensor data 114 in System Configuration Example 1.

First, creation processing for the predictive detection model 117 in System Configuration Example 2 will be described. In the user site 201, the apparatus to be cooled 101 outputs, to the sampling processing section 102, analog data detected by the sensors 112, and the sampling processing section 102 outputs the sensor data 114 to the data preprocessing section 103. By excluding outliers from the sensor data 114 or interpolating the sensor data 114 at missing points of time, the data preprocessing section 103 outputs the feature amount 115 to the first communication control section 210. The user site 201 causes the first communication control section 210 to transmit the feature amount 115 to the third communication control section 230 of the cloud site 203.

The cloud site 203 causes the third communication control section 230 to transfer the feature amount 115 from the user site, to the second communication control section 220 of the operation site 202.

In the operation site 202, the second communication control section 220 outputs the feature amount 115 from the user site 201, to the model creation section 104. The model creation section 104 uses the training data set (the feature amount 115 and the positive/negative label 116) to create the predictive detection model 117, and outputs the predictive detection model 117 to the second communication control section 220. The second communication control section 220 transmits the predictive detection model 117 to the third communication control section 230 of the cloud site 203.

In the cloud site 203, the third communication control section 230 outputs the predictive detection model 117 from the operation site 202, to the predictive detection section 105.

Now, predictive detection processing by the predictive detection model 117 in System Configuration Example 2 will be described. In the user site 201, the apparatus to be cooled 101 outputs, to the sampling processing section 102, analog data detected by the sensors 112, and the sampling processing section 102 outputs the sensor data 114 to the data preprocessing section 103. By excluding outliers from the sensor data 114 or interpolating the sensor data 114 at missing points of time, the data preprocessing section 103 outputs the feature amount 115 to the first communication control section 210. The user site 201 causes the first communication control section 210 to transmit the feature amount 115 to the third communication control section 230 of the cloud site 203.

In the cloud site 203, the third communication control section 230 outputs, to the predictive detection section 105, the feature amount 115 from the user site 201. The predictive detection section 105 inputs the feature amount 115 to the predictive detection model 117, and outputs the diagnosis result 118 indicating a predictive sign of a degraded cooling capability of the oil cooling section 113.

### <Configuration Example of Apparatus to be Cooled 101>

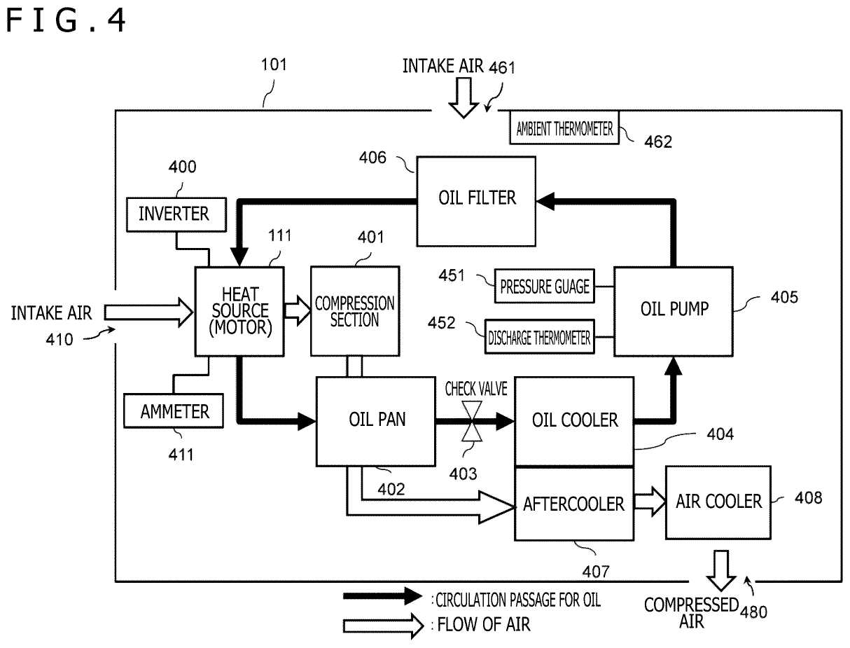

FIG. 4 is a block diagram illustrating a configuration example of the apparatus to be cooled 101. With reference to FIG. 4, the apparatus to be cooled 101 will be described taking an air compressor as an example. The apparatus to be cooled 101 includes an inverter 400, the heat source 111 such as a motor, a compression section 401, an oil pan 402, a check valve 403, an oil cooler 404, an oil pump 405, an oil filter 406, an aftercooler 407, and an air cooler 408. The inverter 400 performs rotation control on a motor, which is the heat source 111. With an increase in the frequency of an AC (Alternating Current) voltage resulting from conversion by the inverter 400, a load on the motor increases to rotate the motor at high speed, causing the compression section 401 to generate more compressed air. Further, the apparatus to be cooled 101 includes a first intake port 410, a second intake port 461, and an exhaust port 480.

Further, the apparatus to be cooled 101 includes, as the sensors 112, an ammeter 411, a pressure gauge 451, a discharge thermometer 452, and an ambient thermometer 462. The ammeter 411 detects a current value of the heat source 111. The pressure gauge 451 detects a discharge pressure of oil. The discharge thermometer 452 detects a discharge temperature of oil. The ambient thermometer 462 detects an ambient temperature of the apparatus to be cooled 101 by using air from the second intake port 461. Note that the sensor 112 detects a voltage frequency of the inverter 400. Further, analog data output from each sensor 112 is sampled by the sampling processing section 102 at the same timing.

A circulation passage for oil provided by the oil cooling section 113 is a passage from the heat source 111 through the oil pan 402, the check valve 403, the oil cooler 404, the oil pump 405, and the oil filter 406 to the heat source 111.

Further, an air flow is a passage from the first intake port 410 through the heat source 111, the compression section 401, the aftercooler 407, and the air cooler 408 to the exhaust port 480, and compressed air generated by the compression section 401 is discharged from the exhaust port 480.

### <Hardware Configuration Example of Computer (User Site 201, Operation Site 202, Cloud Site 203)>

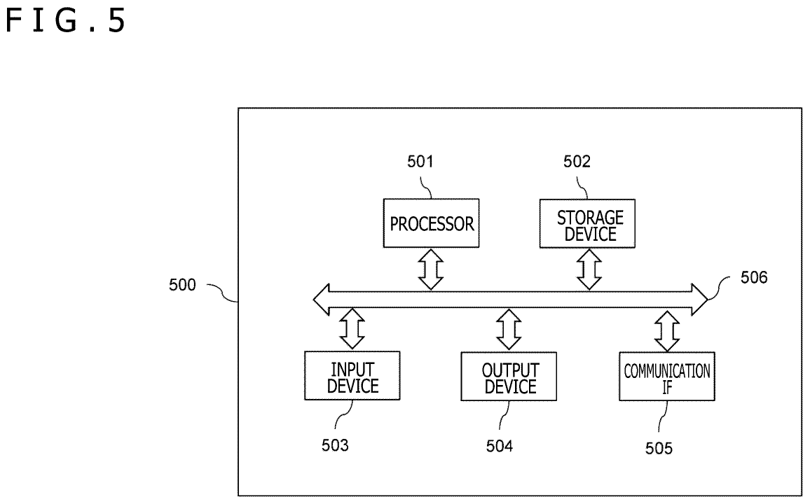

FIG. 5 is a block diagram illustrating a hardware configuration example of a computer. A computer 500 includes a processor 501, a storage device 502, an input device 503, an output device 504, and a communication interface (communication IF) 505. The processor 501, the storage device 502, the input device 503, the output device 504, and the communication IF 505 are connected together by a bus 506. The processor 501 controls the computer 500. The storage device 502 is a work area for the processor 501. Further, the storage device 502 is a non-transitory or transitory recording medium storing various kinds of programs and data. The storage device 502 is, for example, a ROM (Read Only Memory), a RAM (Random Access Memory), an HDD (Hard Disk Drive), or a flash memory. The input device 503 inputs data. The input device 503 is, for example, a keyboard, a mouse, a touch panel, ten keys, a scanner, a microphone, or a sensor. The output device 504 outputs data. The output device 504 is, for example, a display, a printer, or a speaker. The communication IF 505 is connected to a network to transmit and receive data to and from the network.

### <Example of Data Preprocessing>

Now, an example of data preprocessing by the data preprocessing section 103 will be described.

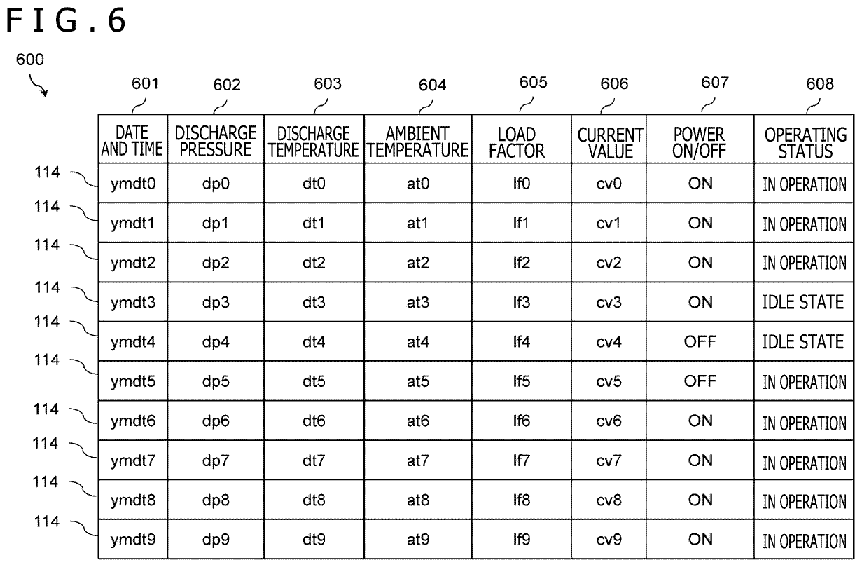

FIG. 6 is an explanatory diagram illustrating an example of a sensor data table. A sensor data table 600 is present in the computer 500 holding the sensor data 114. The sensor data table 600 is a table including the sensor data 114 as entries, and includes, as fields, a date and time 601, a discharge pressure 602, a discharge temperature 603, an ambient temperature 604, a load factor 605, current value 606, power ON/OFF 607, and an operating status 608.

The date and time 601 is the date and time when the sampling processing section 102 sampled analog data from the sensors 112. The discharge pressure 602 is a discharge pressure value of oil at the date and time when the sampling processing section 102 sampled analog data from the pressure gauge 451. The discharge temperature 603 is a discharge temperature of oil at the date and time when the sampling processing section 102 sampled analog data from the discharge thermometer 452. The ambient temperature 604 is an ambient temperature of the apparatus to be cooled 101 at the date and time when the sampling processing section 102 sampled analog data from the ambient thermometer 462.

The load factor 605 is a value indicating the rate of an operating load imposed on the motor, which is the heat source 111, at the date and time when the sampling processing section 102 sampled analog data (frequency of the AC voltage) from the inverter circuit 544. The load factor 605 increases and decreases consistently with the frequency of the AC voltage resulting from conversion by the inverter 400.

The current value 606 is a value of a current applied to the heat source 111 at the date and time when the sampling processing section 102 sampled analog data from the ammeter 411. The power ON/OFF 607 indicates a value indicating whether power to the apparatus to be cooled 101 was ON or OFF at the date and time when the sampling processing section 102 sampled analog data from the sensors 112. The operating status 608 is a value indicating whether the apparatus to be cooled 101 was in operation or in an idle state at the date and time when the sampling processing section 102 sampled analog data from the sensors 112.

The data preprocessing section 103, for example, outputs the feature amount 115 in a case where the load factor 605 in the sensor data 114 is equal to or greater than a threshold, and outputs no feature amount 115 in a case where the load factor 605 is less than a threshold.

Further, the data preprocessing section 103 may output, as a first feature amount 115, the sensor data 114 equal to or greater than a first threshold, and output, as a second feature amount 115, the sensor data 114 less than a second threshold lower than the first threshold. Note that, in this case, the model creation section 104 may create a first predictive detection model 117 by using the first feature amount 115, and may create a second predictive detection model 117 by using the second feature amount 115.

Further, for chronological data regarding the discharge temperature 603 of oil among the set of pieces of chronological sensor data 114, the data preprocessing section 103 calculates a moving average value for a predetermined duration for each date and time 601. Further, within a range of the maximum value to the minimum value of the moving average values calculated for the respective dates and times 601, the data preprocessing section 103 may determine the sensor data 114 corresponding to the top p % or more of the moving average values to be the feature amount 115 and output the feature amount 115, while refraining from outputting the sensor data 114 corresponding to less than top p % of the moving average values as the feature amount 115.

Further, the data preprocessing section 103 may output, as the feature amount 115 at a certain date and time 601 (labeled as t1), the sensor data 114 at the date and time t1 and a statistical amount of the sensor data 114 from a date and time to (a date and time that is a predetermined time T before the date and time t1) to the date and time t1. The statistical amount is, for example, at least one of the maximum value, the minimum value, an average value, a variance, a standard deviation, an autocovariance, and an autocorrelation of each of the elements included in the sensor data 114 (the discharge pressure 602, the discharge temperature 603, the ambient temperature 604, the load factor 605, the current value 606, the power ON/OFF 607, and the operating status 608).

For example, the sampling processing section 102 is assumed to have a sampling period of 30 minutes. When the date and time t1 is assumed to be 12:30 on a certain day of a certain month of a certain year and the predetermined time T is assumed to be 12 hours, the date and time to is 0:30 on the certain day. In this case, the data preprocessing section 103 calculates the statistical amount of the sensor data 114 every 30 minutes from 0:30 (date and time to) until 12:30 (date and time t1). The data preprocessing section 103 outputs, as the feature amount 115 at 12:30 (date and time t1), the sensor data 114 at 12:30 (date and time t1) and the statistical amount of the sensor data 114 obtained every 30 minutes from 0:30 (date and time to) until 12:00, which is a date and time immediately preceding 12:30 (date and time t1).

Note that, in a case where the sampling period is equal to or shorter than a predetermined period, the sensor data 114 is enormous in amount. In particular, in System Configuration Example 2 depicted in FIG. 3, in a case where there is an increase in the amount of data transmitted from the first communication control section 210 to the third communication control section 230, and the amount of data that can be communicated between the user site 201 and the cloud site 203 is limited, then data transmission from the user site 201 to the cloud site 203 is disabled. In preparation for such a case, the data preprocessing section 103 converts the sensor data 114 into a frequency component by fast Fourier transform.

For example, the sampling processing section 102 is assumed to have a sampling period of 10 msec. When the date and time t1 is assumed to be 12:30 on a certain day of a certain month of a certain year and the predetermined time T is assumed to be 30 minutes, the date and time to is 12:00 on the certain day. In this case, the data preprocessing section 103 converts the sensor data 114 obtained every 10 sec from 12:00 (date and time to) until 12:30 (date and time t1), into a frequency component by fast Fourier transform, and outputs the frequency component as the feature amount 115 at 12:30 (date and time t1). Note that the feature amount 115 of the frequency component may be directly used at the operation site 202 to create the predictive detection model 117 or may be subjected to inverse fast Fourier transform at the operation site 202 and thus converted into a chronological feature amount 115.

### <Example of Creation of Predictive Detection Model>

Now, an example of creation of a predictive detection model by the model creation section 104 will be described. The model creation section 104 executes generation of a training data set (the feature amount 115 and the positive/negative label 116) and generation of the predictive detection model 117. First, generation of the training data set (the feature amount 115 and the positive/negative label 116) will be described.

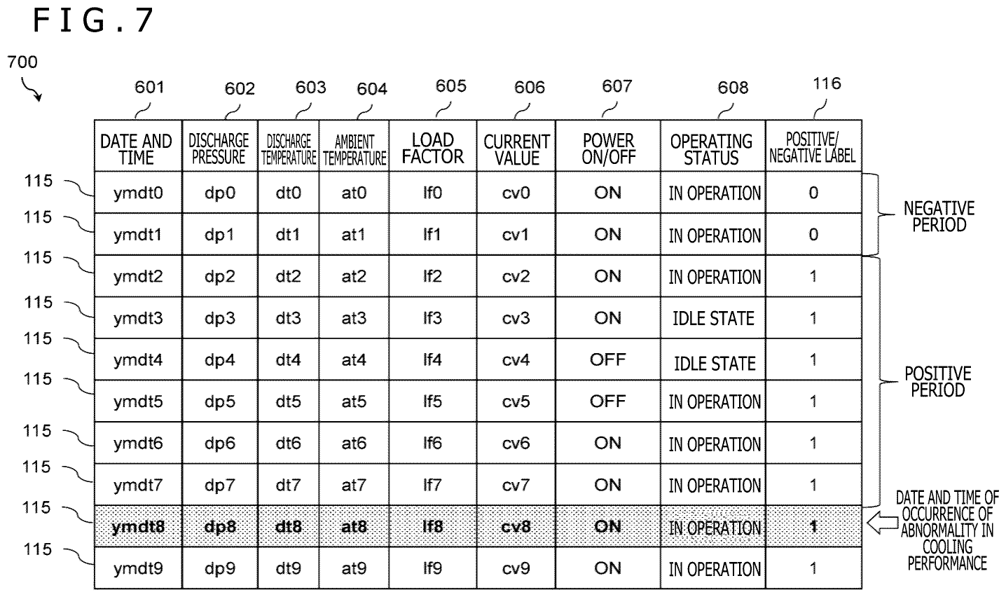

FIG. 7 is an explanatory diagram illustrating an example of a training data set. A training data set table 700 is present in a computer 500 holding the feature amount 115. The training data set table 700 is a table including the feature amount 115 and the positive/negative label 116 as entries, and including, as fields, the date and time 601, the discharge pressure 602, the discharge temperature 603, the ambient temperature 604, the load factor 605, the current value 606, the power ON/OFF 607, the operating status 608, and the positive/negative label 116.

The model creation section 104 receives input of the date and time of occurrence of an abnormality in cooling capability through an operational input made by an operator of the operation site 202. When the date and time 601 of occurrence of an abnormality is denoted by t1, the model creation section 104 sets, as a positive period, a period from a date and time (t1−T) that is the predetermined time T before the date and time t1 of occurrence of the abnormality to the date and time t1, and sets the positive/negative label 116 of the feature amount 115 for the positive period to “1” indicating positivity. Further, the model creation section 104 sets, as a negative period, a period before the date and time (t1−T) to which the positive/negative label 116 is not provided, and sets the positive/negative label 116 of the feature amount 115 for the negative period to “0” indicating negativity. This generates a training data set for each feature amount 115.

Further, the model creation section 104 generates a training data set for each feature amount 115 by determining a temperature rise period from the start to the end of a rise in the discharge temperature 603 in a set of pieces of the chronological sensor data 114.

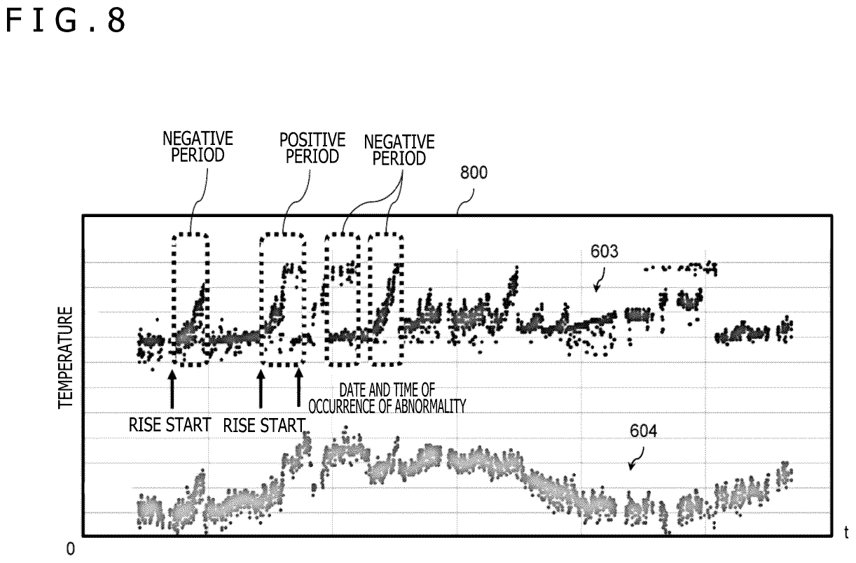

FIG. 8 is a graph illustrating chronological data regarding the discharge temperature 603 and the ambient temperature 604. In a graph 800, the model creation section 104 determines a rising trend period in which the discharge temperature 603 continuously rises at a predetermined gradient or larger. The start date and time of the period is the date and time corresponding to the minimum value of the discharge temperature 603 and is the date and time of start of a rise. Further, in a case where the discharge temperature 603 at a certain date and time lowers by a predetermined temperature or greater at the next date and time (for example, the discharge temperature 603 at the date and time of the start of the rise or lower), the certain date and time is the rise end date and time. The model creation section 104 determines a period from the date and time of rise start to the date and time of rise end to be a temperature rise period.

In a case where the temperature rise period includes the date and time of occurrence of an abnormality in cooling capability, the model creation section 104 sets the temperature rise period as a positive period, and sets the positive/negative label 116 for the feature amount 115 in the positive period to “1” indicating positivity. On the other hand, in a case where the temperature rise period includes no date and time of occurrence of an abnormality in cooling capability, the model creation section 104 sets the temperature rise period as a negative period, and sets the positive/negative label 116 for the feature amount 115 in the negative period to “0” indicating negativity. Further, the model creation section 104 may set a period other than the temperature rise period as a negative period and set the positive/negative label 116 for the feature amount 115 in the negative period to “0” indicating negativity.

Now, generation of the predictive detection model 117 will be described. The model creation section 104 uses the training data set to generate the predictive detection model 117 by, for example, decision trees, random forests, or deep learning.

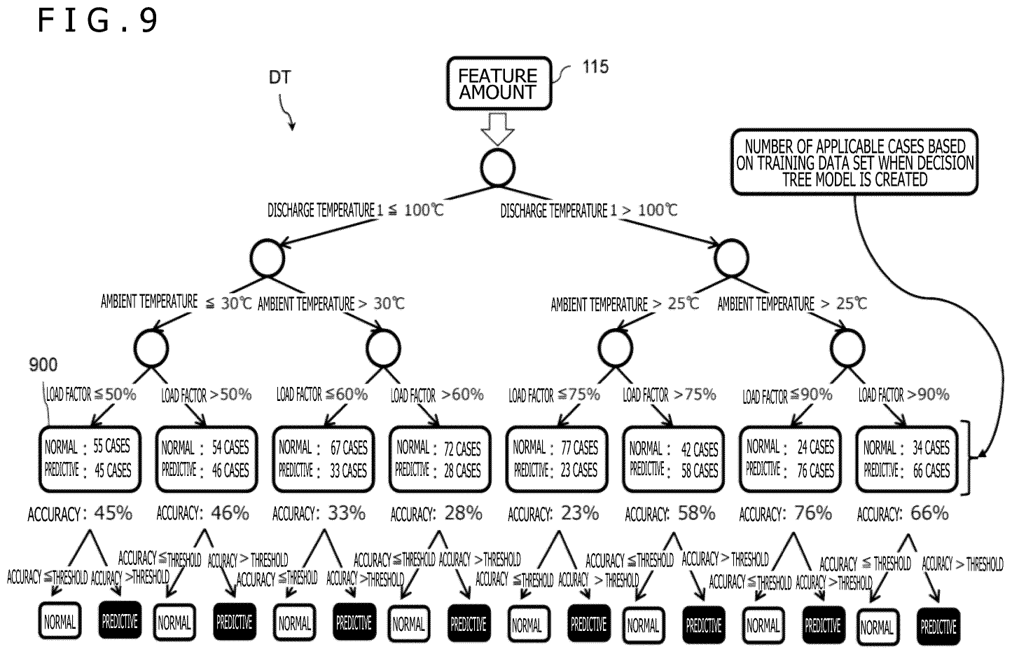

FIG. 9 is an explanatory diagram illustrating Generation Example 1 for the predictive detection model 117. In Generation Example 1, a decision tree DT is generated. The decision tree DT includes branch conditions for elements (in FIG. 9, for simplification, the discharge temperature 603, the ambient temperature 604, and the load factor 605 as an example) of the feature amount 115 for each node. The model creation section 104 provides the feature amount 115 to the decision tree DT, associates the number of normal cases (positive/negative label 116 of “0”) with the number of abnormal cases (positive/negative label 116 of “1”) for each terminal node, and calculates a predictive accuracy for occurrence of an abnormality. The predictive accuracy is calculated by the number of predictive cases/(normal cases+predictive cases) for each terminal node. Thus, the decision tree DT is created.

By using the decision tree DT as the predictive detection model 117, the predictive detection section 105 inputs, to the decision tree DT, the feature amount 115 to be predicted, to determine the terminal node reached by the feature amount 115 to be predicted. In a case where the reached terminal node has a predictive accuracy higher than a preset threshold, the diagnosis result for the input feature amount 115 to be predicted is positive (predictive period). In a case where the reached terminal node has a predictive accuracy equal to or lower than the preset threshold, the diagnosis result for the input feature amount 115 is negative (normal period).

For example, in a case where the input feature amount 115 to be predicted reaches the terminal node 900, the diagnosis result for the input feature amount 115 to be predicted is positive (predictive) if the predictive accuracy of 45% is greater than the preset threshold, and the input feature amount 115 to be predicted is negative (normal) if the predictive accuracy of 45% is equal to or lower than the preset threshold.

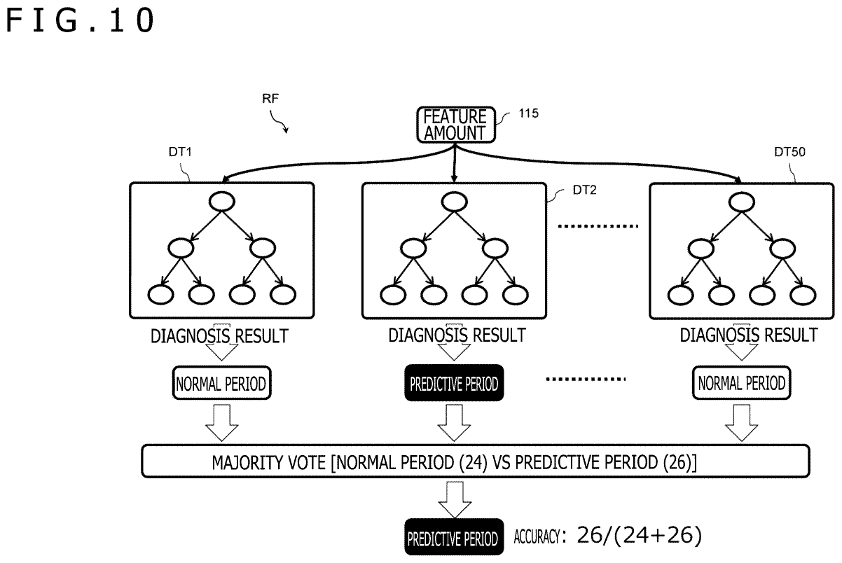

FIG. 10 is an explanatory diagram illustrating Generation Example 2 for the predictive detection model 117. In Generation Example 2, a random forest RF is generated by coupling a plurality of decision trees DT1, DT2, . . . , DT50. Each of the decision trees DT1, DT2, . . . , DT50 is created using a combination of elements that are the same as or different from the elements of the feature amount 115 adopted at the nodes by the other decision trees. The branch conditions may vary even in a case where the same elements are used.

By using the random forest RF as the predictive detection model 117, the predictive detection section 105 inputs, to the random forest RF, the feature amount 115 to be predicted, to determine, for each of the decision trees DT1, DT2, . . . , DT50, the terminal nodes reached by the feature amount 115 to be predicted. The predictive detection section 105 takes a vote on the diagnosis result (normal period or predictive period) for each of the decision trees DT1, DT2, . . . , DT50, and outputs the final diagnosis result for the feature amount 115 to be predicted. In FIG. 10, the majority vote results in the predictive period.

In this manner, according to the present examples, a predictive sign of occurrence of an abnormality in cooling capability of the oil cooling section 113 can be detected by focus being placed on the load on the apparatus to be cooled 101 or a rise in oil temperature. Accordingly, in a case where the load on the apparatus to be cooled 101 is focused on, the predictive sign of occurrence of an abnormality in cooling capability of the oil cooling section 113 can be detected without depending on a rise in oil temperature. Further, in a case where a rise in oil temperature is focused on, a direct predictive sign of occurrence of an abnormality due to a rise in oil can be detected. Hence, in any case, the present examples can suppress a degraded capability attributable to occurrence of an abnormality in the apparatus to be cooled 101, shutdown of the apparatus to be cooled 101, and a failure in the apparatus to be cooled 101 before the degradation, shutdown, or failure occurs.

Note that, in the examples described above, the apparatus to be cooled 101 has been described taking an air compressor as an example but the apparatus to be cooled 101 may be a rolling mill or an engine.

Note that the present invention is not limited to the examples described above and includes variations and equivalents within the scope of the attached claims. For example, detailed description of the examples has been provided above in order to describe the present invention in an easy-to-understand manner, and the present invention is not limited to including all the components described above. Further, the configuration of a certain example may be partly replaced with the configuration of another example. Further, the configuration of a certain example may be added to the configuration of another example. Further, the configuration of each example may be partly added to, deleted from, or replaced with the configuration of another example.

Further, each of the configurations, functions, processing sections, processing means, and the like may be implemented in hardware by using, for example, an integrated circuit to design a part or all of the configuration, the function, the processing section, the processing mean, or the like, or may be implemented in software by a processor interpreting and executing programs implementing the functions.

Such information as a program, a table, and a file which implements each function can be stored in a storage apparatus such as a memory, a hard disk, or an SSD (Solid State Drive), or a recording medium such as an IC (Integrated Circuit) card, an SD (Secure Digital) card, or a DVD (Digital Versatile Disc).

Further, control lines and information lines illustrated are considered necessary for description, and not all the control lines and information lines required for implementation are illustrated. In practice, substantially all the configurations may be considered to be interconnected.

1. A predictive detection apparatus comprising:
a preprocessing section that acquires a chronological feature amount indicating an operational status of an apparatus to be cooled which includes a heat source and a cooling section that cools the heat source with a cooling medium; and
a model creation section that generates a training data set in reference to the chronological feature amount acquired by the preprocessing section and a label indicating whether a cooling capability provided by the cooling section is normal or abnormal, and that uses the training data set to create a predictive detection model.

2. The predictive detection apparatus according to claim 1, wherein
the preprocessing section acquires chronological sensor data indicating the operational status of the apparatus to be cooled which is detected by the apparatus to be cooled and including an operating load on the heat source, and acquires, as the feature amount, sensor data indicating the operating load equal to or greater than a threshold from among the pieces of chronological sensor data.

3. The predictive detection apparatus according to claim 1, wherein
the preprocessing section acquires chronological sensor data indicating the operational status of the apparatus to be cooled which is detected by the apparatus to be cooled and including a temperature of the cooling medium, and acquires, as the feature amount, sensor data indicating the temperature equal to or higher than a threshold from among the pieces of chronological sensor data.

4. The predictive detection apparatus according to claim 1, wherein
the preprocessing section acquires, as the feature amount, chronological sensor data indicating the operational status of the apparatus to be cooled which is detected by the apparatus to be cooled and including a temperature of the cooling medium, and
the model creation section generates the training data set according to a rising trend of the temperature in the feature amount.

5. The predictive detection apparatus according to claim 1, wherein
The preprocessing section frequency-converts chronological sensor data indicating the operational status of the apparatus to be cooled which is detected by the apparatus to be cooled, to acquire the feature amount of a frequency component.

6. The predictive detection apparatus according to claim 1, comprising:
a predictive detection section that inputs the feature amount of a prediction target to the predictive detection model, to output a diagnosis result diagnosing a cooling capability provided by the cooling section.

7. A predictive detection system comprising:
a first apparatus including an apparatus to be cooled which includes a heat source and a cooling section that cools the heat source with a cooling medium;
a second apparatus including a label indicating whether a cooling capability provided by the cooling section is normal or abnormal, and
a third apparatus that is able to communicate with the first apparatus and the second apparatus, wherein
the second apparatus includes
a preprocessing section that acquires a chronological feature amount indicating an operational status of the apparatus to be cooled, and
a model creation section that generates a training data set in reference to the chronological feature amount acquired by the preprocessing section and the label, and that uses the training data set to create a predictive detection model, and
the third apparatus includes
a preprocessing section that acquires a chronological feature amount indicating an operational status of the apparatus to be cooled, and
a predictive detection section that inputs the feature amount of a prediction target acquired by the preprocessing section to the predictive detection model acquired by the model creation section, to output a diagnosis result diagnosing the cooling capability provided by the cooling section.

8. A predictive detection system comprising:
a first apparatus including an apparatus to be cooled which includes a heat source and a cooling section that cools the heat source with a cooling medium;
a second apparatus including a label indicating whether a cooling capability provided by the cooling section is normal or abnormal, and
a third apparatus that is able to communicate with the first apparatus and the second apparatus, wherein
the first apparatus includes
a preprocessing section that acquires a chronological feature amount indicating an operational status of the apparatus to be cooled,
the second apparatus includes
a model creation section that generates a training data set according to the chronological feature amount acquired by the preprocessing section and the label, and that uses the training data set to create a predictive detection model, and
the third apparatus includes
a predictive detection section inputting the feature amount of a prediction target to the predictive detection model to output a diagnosis result diagnosing the cooling capability provided by the cooling section.

9. The predictive detection system according to claim 8, wherein,
in the first apparatus, the preprocessing section frequency-converts chronological sensor data indicating the operational status of the apparatus to be cooled which is detected by the apparatus to be cooled, to acquire the feature amount of a frequency component, and,
in the second apparatus, the model creation section generates the training data set in reference to the chronological feature amount of the frequency component acquired by the preprocessing section and the label, and creates the predictive detection model.

10. A predictive detection method executed by a predictive detection apparatus including a processor that executes a program and a storage device that stores the program, wherein
the processor executes
preprocessing of acquiring a chronological feature amount indicating an operational status of an apparatus to be cooled which includes a heat source and a cooling section that cools the heat source with a cooling medium, and
creation processing of generating a training data set in reference to the chronological feature amount acquired by the preprocessing and a label indicating whether a cooling capability provided by the cooling section is normal or abnormal, and using the training data set to create a predictive detection model.
